(19) United States
(12) Patent Application Publication
(10) Pub. No.: US 2010/0000992 A1
(43) Pub. Date: Jan. 7, 2010

(54) Microwave Steamer

(76) Inventor: Valentine Hechler, Northfield, IL (US)

Correspondence Address: NIXON PEABODY, LLP, 401 9TH STREET, NW, SUITE 900, WASHINGTON, DC, 20004-2128, US

(21) Appl. No.: 12/399,822

(22) Filed: Mar. 6, 2009

Related U.S. Application Data
(60) Provisional application No. 61/034,396, filed on Mar. 6, 2008.

(51) Int. Cl. H05B 6/80

(52) U.S. Cl. 219/729; 219/731

(57) ABSTRACT

A vessel for cooking food includes a cooker container, a boiler container and a lid. The cooker container includes a bottom wall and at least one side wall formed from a microwave shielding material. The bottom wall has one or more apertures. The boiler container receives the bottom wall of the cooker container. The boiler container is formed from a microwave transmitting material. The lid is removably coupled to a top portion of the cooker container. The lid is made from a microwave shielding material.

### CROSS-REFERENCE TO RELATED APPLICATION

This application claims the benefit of U.S. Provisional Patent Application No. 61/034,396, filed Mar. 6, 2008, entitled “Microwave Steamer,” which is hereby incorporated by reference in its entirety.

### FIELD OF THE INVENTION

The present invention relates generally to a method and apparatus for steaming food. More particularly, the present invention relates to a method and apparatus for steaming food in a microwave oven.

### BACKGROUND OF THE INVENTION

For many years steam cooking has been practiced by many cultures throughout the world. Essentially, a pot of water set upon an open fire has been boiled to create steam. This steam has then been percolated through baskets or other utensils having openings for the steam to pass for the purpose of cooking food contained within such baskets or utensils. The advantage of such cooking is making the food more tender and moist, and with proper seasoning, very tasty to suit the desires of any particular culture.

With the advent of microwave ovens many inventions have claimed success in duplicating the results just mentioned. Unfortunately, in such ovens the food being steamed has not been completely isolated from the microwaves. Thus, the microwaves overpower the steam as the primary source of energy doing the cooking. The resulting meat, fish or poultry is often excessively cooked at the thinner sections while being underdone at the thicker ones. Asparagus, mushrooms and other delicate watery vegetables are often cooked to mush because microwaves are drawn to their water.

### SUMMARY

A vessel for cooking food includes a cooker container, a boiler container and a lid. The cooker container includes a bottom wall and at least one side wall formed from a microwave shielding material. The bottom wall has one or more apertures. The boiler container receives the bottom wall of the cooker container. The boiler container is formed from a microwave transmitting material. The lid is removably coupled to a top portion of the cooker container. The lid is made from a microwave shielding material.

### BRIEF DESCRIPTION OF THE DRAWINGS

The foregoing and other advantages of the invention will become apparent upon reading the following detailed description and upon reference to the drawings.

FIG. 1 is a sectional side view of a microwave steamer according to one embodiment.

FIG. 2 is another side view of the microwave steamer of FIG. 1.

FIG. 3 is a top view of a lid of the microwave steamer of FIG. 1

FIG. 4 is a bottom view of a surface of the microwave steamer of FIG. 1.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

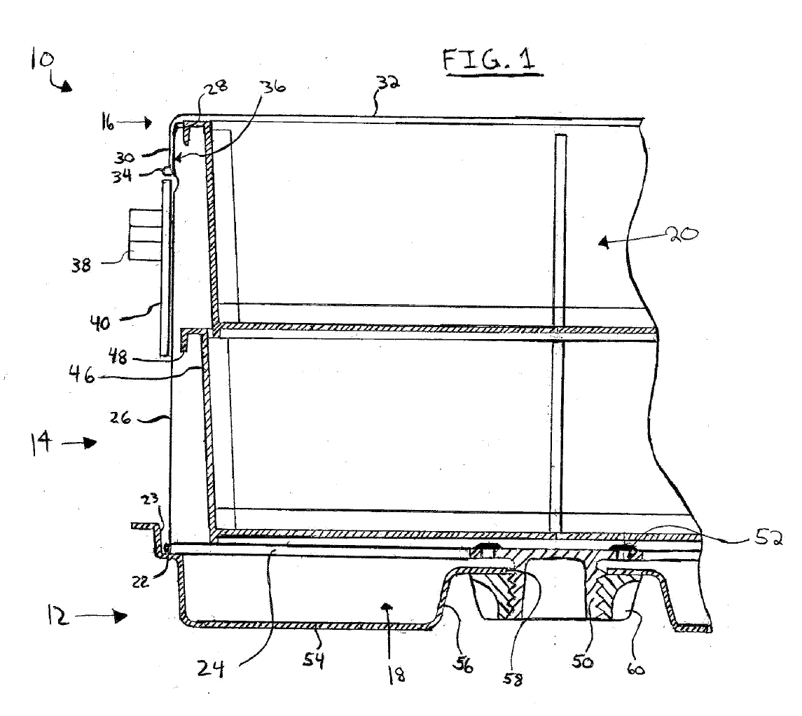

Turning to FIG. 1, a sectional side view of a microwave steamer 10 is shown. The microwave steamer 10 includes a boiler container 12, a cooker container 14 and a lid 16. The boiler container 12 is placed below the cooker container 14 and the lid 16 is placed above the cooker container 14 thereby separating the microwave steamer 10 into two chambers, a steam generating chamber 18 and a food cooking chamber 20.

The microwave steamer 10 is designed to permit microwaves to heat water in the steam chamber 18 but prohibit microwaves from directly heating food within the cooking chamber 20. The boiler container 12 is made from microwave transmitting material(s) and thereby permits microwaves to reach and heat the water (or other fluids) within the boiler container 12. The cooker container 14 and the lid 16 are made from microwave shielding material(s) and thereby block microwaves from reaching the food within the cooking chamber 20. Nonlimiting examples of suitable microwave shielding materials include aluminium, aluminium alloys, zinc-plated steel, tin-plated steel, polymer-coated steel combinations thereof and the like. The interior surfaces of the cooker container 14 and the lid 16 are coated with chemicals and/or materials that mitigate rusting and corrosion. For example, an epoxy paint or powder coating can be utilized. As will be discussed in further detail below, apertures 44 in the bottom of the cooker container 14 pass steam from the boiler container 12 to cook the food within the cooking chamber 20. The apertures 44 can have a sufficiently small shape and size to prevent microwaves entering the cooking chamber 20 thus ensuring that the food is primarily cooked by steam from the steam chamber 18 and not directly by microwaves.

Skilled artisans recognize that discontinuities in containers that are not microwave transparent (i.e., made from microwave transmitting materials) may cause arcing because microwave radiation becomes concentrated at such discontinuities (e.g., at an intersection of two side walls or a side wall and a bottom surface). While the microwave steamer 10 can be manufactured to have any cross-sectional shape, a smoothly contoured side shape such as a circle or oval advantageously minimizes the number of discontinuities and the risk of arcing.

The boiler container 12 includes a flange portion 22. In FIG. 1, the flange portion 22 extends outwardly at or near the upper end 23 of the boiler container 12 to provide a surface for the cooker container 14 to seat upon and thereby maintain the cooker container 14 at a height above the water disposed within the steam chamber 18. In alternative embodiments, the flange portion 22 can extend inwardly at or near the upper end 23 of the boiler container 12.

The cooker container 14 includes a bottom 24 and a circular side wall 26 having a substantially uniform height. According to one embodiment, the height of cooker container 14 is approximately 7.25 inches. In an alternative embodiment, the height of the cooker container 14 is approximately 6.75 inches. The bottom 24 of the cooker container 14 has a sufficient diameter to be supported by the flange portion 22 of the boiler container 12. According to some embodiments, the diameter of the cooker container 14 is approximately 10 inches. When seated on the flange portion 22 of the boiler container 12, the cooker container 14 can be laterally spaced from the upper end 23 of the boiler container 12.

The upper end of the side wall 26 terminates in a rim 28, which defines an opening through which food can be placed in the cooker container 14. The lid 16 has a shape which matches and mates with the shape of the side wall 26 and/or the rim 28 to effect a snug fitting seal. Because both the cooker container 14 and the lid 16 are microwave shielding materials, it is important to maintain firm contact between the cooker container 14 and the lid 16 to minimize the risk of arcing. Arcing can be further mitigated by utilizing reflective materials (i.e., materials having shiny surfaces) for the cooker container 14 and the lid 16.

In the embodiment illustrated, the lid 16 has a sleeve portion 30 that extends downward from the periphery of a top surface 32 of the lid 16 and terminates in a ring 34. When the lid 16 is pressed downward onto the cooker container 14, the sleeve portion 30 overlaps the rim 28 and a mating portion 36 of the side wall 26 to effect a slip fit mating between the sleeve portion 30 and the mating portion 36. The lid 16 and the cooker container 14 should be sized so that the circularly shaped cooker container 14 exerts a radially outward force on the circularly shaped lid 16 to further maintain tight sealing engagement. In the illustrated embodiment, the diameter of the lid is slightly greater than the diameter of the mating portion 36. Additionally, the length of the sleeve portion 30 that overlaps the mating portion 36 of the side wall 26 is sufficient to provide a contact area between the sleeve portion 30 and the mating portion 36 such that there are no cracks or other apertures. This ensures a tight seal, which simultaneously prevents arcing and microwaves from entering the cooking chamber 20.

In operation, steam in the steam chamber 18 can approach 212° F. (100° C.). As the steam impinges upon the inside of the cooker container 14 and the lid 16, the inner surfaces of the cooker container 14 and the lid 16 heat up. Many microwave shielding materials such as, for example, metals expand when heated. Because the cooker container 14 and the lid 16 are maintained in a snug slip fit mating engagement at room temperature, thermal expansion causes the cooker container 14 to exert an increased force on the lid 16.

A problem is thus presented when the cooker container 14 expands more significantly than the lid 16 causing a significant increase in the frictional forces between the cooker container 14 and the lid 16 and making the lid 16 difficult to remove. To mitigate this problem, a relatively thin gauge of microwave shielding material can be utilized for the cooker container 14 and/or the lid 16. The thinner the material, the less significant the force of the cooker container 14 will exert on the lid 16. It has been found that metals having approximately 0.006 to 0.012 inches thickness substantially minimize the forces at the areas of engagement.

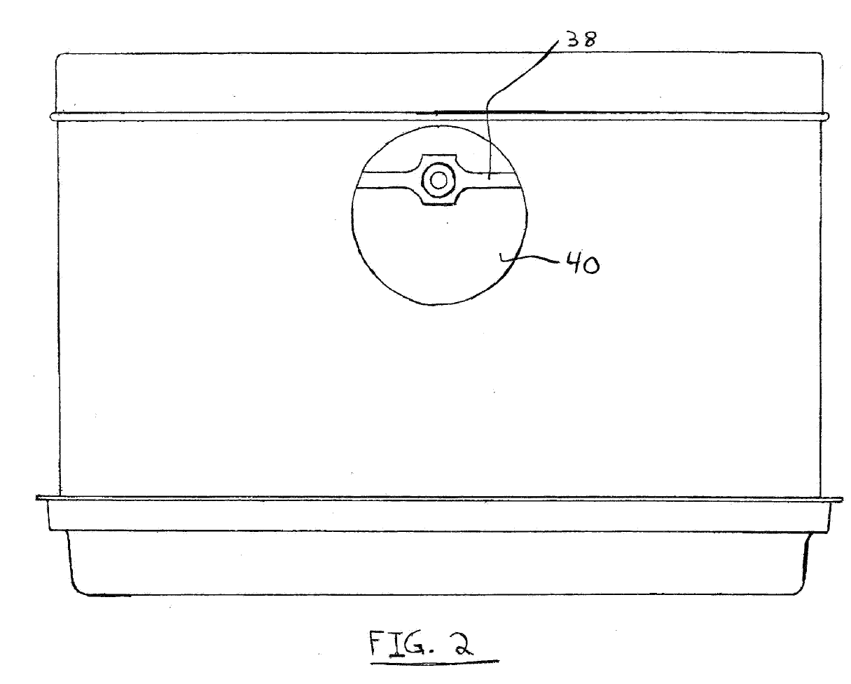

To further mitigate this problem, the cooker container 14 includes cams 40 and extended portions 38 on opposing sides of the side wall 26. The cams 40 and extended portions 38 are also shown in FIG. 2. The cams 40 are mounted to the cooker container 14 by any means that is suitable to allow the cams 40 to rotate. For example, the cams 40 can be mounted to the side wall 26 by a plastic nut and a plastic bolt. The extended portions 38 are coupled to the cams 40 to facilitate rotation of the cams 40 by hand. The position of the cams 40 on the side wall 26 permits the lid 16 to fully mate with the cooker container 14 when the cams 40 are oriented away from the lid 16. When the cams 40 are rotated, the cams 40 engage the ring 34 of the mated lid 16. Upon further rotation, the cams 40 cause the lid 16 to disengage from the cooker container 14. The force required to rotate the cams 40 and thereby disengage the lid 16 from the cooker container 14 may be many times less than the force that would otherwise be required to pry the lid 16 from the cooker container 14.

The extended portions 38 also provide a convenient means for transporting the microwave steamer 10. The extended portions 38 are sized and shaped so as to ensure that the extended portions 38 do not contact the interior walls of a microwave oven (not shown) when stationary or when rotating within the microwave oven.

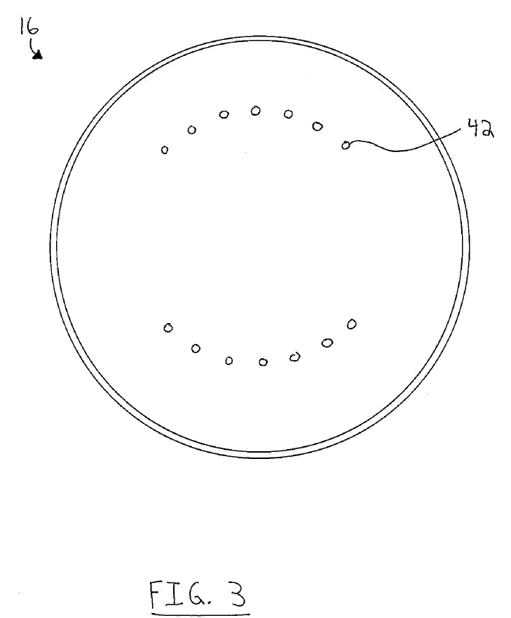

Referring to FIG. 3, the lid 16 includes a plurality of apertures 42 therein. The apertures 42 are sized and shaped to vent steam out of the cooking chamber 20 while at the same time prevent microwaves from entering the cooking chamber 20. However, the apertures 42 should have a diameter of less than approximately 5/32-inch to prevent microwaves from entering the cooking chamber 20. According to some embodiments, the lid can have an outer diameter of approximately 10 1/16-inches and an inner diameter of approximately 9⅞-inches.

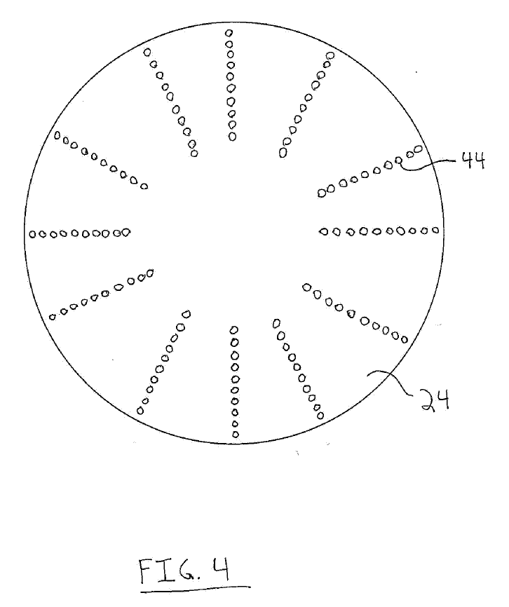

Referring to FIG. 4, a top view of the bottom 24 of the cooker container 14 is shown. The bottom 24 includes apertures 44 that are sized and shaped to permit steam (or gases) to enter the cooking chamber 20 from the steam chamber 18 and prevent microwaves from entering the cooking chamber 20. The apertures 44 have a diameter of approximately 5/32-inch to prevent microwaves from entering the cooking chamber 20. Although the apertures 44 appear to be circular in FIG. 4, the apertures 44 can have any shape so long as the apertures prevent microwaves from entering the cooking chamber 20.

The apertures 44 may be arranged on the bottom 24 in any configuration that is suitable to evenly distribute steam entering the cooking chamber 20 from the steam chamber 18. In the embodiment illustrated, there are 12 rows of 10 apertures 44 offset at a 30 degree angle from one row to the next. The apertures 44 can be manufactured by, for example, a punch process using an air hydraulic press. The amount of steam that is generated during operation of the microwave steamer 10 can be controlled by the power settings of the microwave oven in which the microwave steamer 10 is being irradiated. Thus, a microwave oven operating at the highest power setting will generate more steam than a microwave oven operating at the lowest power setting.

Referring again to FIG. 1, food is suspended above the bottom 24 of the cooker container 14 by one or more trays 46. The trays 46 can be partitioned or plane depending upon the number and types of foods to be cooked. Additionally, the trays 46 can be stackable within the cooker compartment 14. Stackable trays 46 should also be configured to provide sufficient spacing between the trays 46 to allow for food of various sizes to rest on the tray surfaces. The trays 46 can include tray handles 48 that allow for easy removal of the trays 46 from the cooker container 14. According to some embodiments, the trays 46 may be grill shaped.

The boiler container 12 is removably coupled to the cooker container 14 by suitable coupling means. According to the embodiment illustrated, the cooker container 14 includes a threaded portion 50 extending downwards from the bottom 24. The threaded portion 50 is located in axial alignment with the center of cooker container 14. The threaded portion 50 can be secured to the cooker container 14 by any suitable means such as, for example, rivets 52.

The boiler container 12 also includes a bottom surface 54 having a sloped portion 56. The sloped portion 56 terminates in an edge 58, which defines an opening. The opening is sized and located to allow the threaded portion 50 of the cooker container 14 to extend down through the opening when the cooker container 14 is seated on the boiler container 12. A nut 60 configured to mate with the threaded portion 50 through threaded engagement can be screwed onto the threaded portion 50 to secure the boiler container 12 to the cooker container 14. The sloped portion 56 can be configured to allow sufficient clearance for the nut 60 to be actuated by hand. While the sloped portion 56 inhibits boiling water from leaking through the opening in the boiler container 12, it is contemplated that gaskets or other water sealing devices are optionally utilized to further prevent water from leaking out of the boiler container 12.

With the boiler container 12 secured to the cooker container 14 the microwave steamer 10 is easier to transport and safer to operate. The user can grip and transport the microwave steamer 10 using only the cams 38 without having to worry about tipping the boiler container 12 and spilling boiling water. Still, the user can easily remove the boiler container 12 from the cooker container 14 for washing purposes. It is contemplated that the microwave steamer 10 can be machine washable.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A vessel for cooking food comprising:
a cooker container including a bottom wall and at least one side wall, the bottom wall having one or more apertures, the cooker container being formed from a microwave shielding material;
a boiler container receiving the bottom wall of the cooker container, the boiler container being formed from a microwave transmitting material; and
a lid removably coupled to a top portion of the cooker container, the lid being made from a microwave shielding material.

2. The vessel of claim 1, wherein the lid is removably coupled to the top portion of the cooker container by slip fit.

3. The vessel of claim 2, wherein the lid includes a sleeve portion extending downwardly from a top surface of the lid, the sleeve portion overlapping the top portion of the cooker container.

4. The vessel of claim 3, wherein the top portion of the cooker container exerts a radially outward force on the sleeve of the lid.

5. The vessel of claim 1, wherein the cooker container is circular.

6. The vessel of claim 1, wherein the microwave shielding material of the cooker container has a thickness of at least approximately 0.006 inches.

7. The vessel of claim 1, wherein the microwave shielding material of the cooker container has a thickness of less than approximately 0.012 inches.

8. The vessel of claim 1 further comprising one or more cams rotationally coupled to the at least one side wall, the one or more cams uncoupling the lid from the cooker container when the one or more cams are rotated.

9. The vessel of claim 8, wherein the lid includes a sleeve portion extending downwardly from a top surface of the lid, the lid includes a ring at a lowermost end of the sleeve, the cams engaging the ring when rotated.
